(19) United States
(12) Patent Application Publication
(10) Pub. No.: US 2009/0308701 A1
(43) Pub. Date: Dec. 17, 2009

(54) ACTUATOR WITH FUNCTION MONITOR

(75) Inventor: Manfred Gaul, Munchen (DE)

Correspondence Address: King & Spalding LLP, 401 Congress Avenue, Suite 3200, Austin, TX, 78701, US

(73) Assignee: CONTINENTAL AUTOMOTIVE GMBH, HANNOVER (DE)

(21) Appl. No.: 12/374,436

(22) PCT Filed: May 22, 2007
(86) PCT No.: PCT/EP2007/054926

§ 371 Date: Jan. 20, 2009

(30) Foreign Application Priority Data
Jul. 26, 2006 (DE) 10 2006 034 597.5

(51) Int. Cl. F16D 65/14; F16D 65/30; F16D 65/34; G06F 15/00

(52) U.S. Cl. 188/2 D; 188/158; 702/182

(57) ABSTRACT

An actuator (10), particularly a brake actuator for a parking brake in a motor vehicle, with a drive element (20, 200), an output element (30, 32, 300), is coupled with the drive element (20, 200) by at least one elastic element (40, 42, 44, 46, 400), a first sensor (60, 600) for detecting a change in the position of the drive elements (20, 200), and a second sensor (62, 620) for detecting a change in the position of the output element (30, 32, 300).

### CROSS-REFERENCE TO RELATED APPLICATIONS

This application is a U.S. National Stage Application of International Application No. PCT/EP2007/054926 filed May 22, 2007, which designates the United States of America, and claims priority to German Application No. 10 2006 034 597.5 filed Jul. 26, 2006, the contents of which are hereby incorporated by reference in their entirety.

### TECHNICAL FIELD

The present invention relates to an actuator, in particular a brake actuator for a parking brake in a motor vehicle, a method for monitoring the function of an actuator and a computer program and a computer program product for executing the method.

### BACKGROUND

When actuators which are driven electro-mechanically or by electric motor are used for the operation of a parking brake in a motor vehicle it is necessary, for safety engineering reasons, to monitor their correct functioning.

A conventional parking brake system, known from the prior art, generally consists of one wheel brake on each of the two rear wheels of the motor vehicle, a cable pull mechanism and a lockable-position hand lever for operation by the vehicle driver.

In the case of an electro-mechanically operated parking brake system, the hand lever is replaced by an electro-mechanically driven actuating device, which is set into operation as a function of the driving situation by the vehicle driver using an operating button, or by a higher level control unit. The locking and release operation is then electronically controlled or regulated, as appropriate, by the actuating device, if necessary as a function of the current vehicle and operating parameters, such as for example the driver's wishes, driving speed, vehicle weight, vehicle inclination, drive torque, gear selection etc.

From the vehicle and operating data which has been determined, the control or regulation unit then determines a set-point value for the braking force to be generated, and the drive is actuated so that, assuming that the transmission mechanism is functioning correctly, this set braking force is achieved at the wheel brakes. However, due to changing environmental parameters, for example the temperature, humidity etc., and because of wear effects, different braking force values are achieved for the same specified set-point value, so that it is necessary to monitor the achievement of the specified set-point value by measurement of suitable variables at suitable points in the braking system, and by feeding back these values into the control or regulation unit and processing them, to provide closed loop control with appropriate changes to the control variables by which the measured actual braking force continuously approaches the specified set-point value which has been calculated, and eventually reliably reaches it.

If an electric motor is used as the drive, then the drive torque generated can be influenced, for example, by the current strength, operating voltage and by pulse width modulation, as the control variables.

In principle, any of the measurable actuating forces along the path of the force transmission mechanism represents a measure of the actual braking force achieved. However, the further along the force path the measurement point is from the wheel braking unit, the greater is the influence of interference variables which affect the transmission mechanism between the wheel brake and the measurement point, and thereby make the measured values unreliable.

An example of this would be the measurement of the tension produced in a brake cable, where the tension measurement point is located at the actuating device end of the cable. If the cable pull is now blocked on the stretch between the measurement point and the wheel brake, such as by being frozen up at low temperatures, then a braking force would indeed be measured but no braking force would be produced at the wheel brake. To be reliable, a measurement must therefore be made as nearly as possible directly in each wheel brake unit.

On the other hand, such a concept is, in terms of design and assembly, very demanding, expensive and in turn susceptible to interference due to the long signal transmission paths. Seen from this point of view, it would be desirable for the actual braking force to be sensed as centrally as possible, i.e. as near to the control unit as possible, where the control unit is arranged to be immediately on or in the housing of the actuator or the actuating device.

This conflict of objectives is resolved in that, in the case of central measurement close to or actually in the actuating device, at least one second control variable which has a relationship with the braking force is measured for the purpose of verifying the value of the braking force measurement. An obvious candidate for this is the position of braking elements, such as the brake pads, in the wheel brake unit. This is also transmitted along the transmission mechanism, for example a brake cable or brake rod, back to the actuating device, where it can also be sensed centrally and close to the control unit.

The two variables of actuation force and actuator travel have an unambiguous relationship to each other which may indeed even be subject to certain fluctuations, e.g. temperature-related length changes within the transmission mechanism or effects due to ageing or wear, but which are nevertheless not subject to step changes and are thus simple to track and record.

When the functioning is correct, a particular actuation force can be unambiguously assigned to a particular actuator travel. The graph of the actuation force against the actuator travel can be stored in the control unit as a reference curve. For each actuation operation, i.e. each pulling on or release of the brake, the actually measured graph of actuation force/actuator travel can be compared with the expected graph stored in the control unit. In the event of a blockage of the transmission mechanism, the measured actuation force would rise even after a significantly shorter actuator travel, or in the case of a broken actuation mechanism there would be no measurable rise in the actuation force even for a significantly greater actuator travel. In this way, even malfunctions of the brake unit can be reliably detected, and appropriate safety measures initiated.

To date, there exist different solutions for measuring the two actuation variables. Thus, in the solution disclosed in the document EP 0 966 376 B1, the actuation force is measured in or on a brake cable. For the measurement of the actuation force, use has been made to date exclusively of spring excursion measurement elements, as illustrated in the documents EP 0 988 203 B1 and DE 101 02 685 B4. Here, the linear change in the length of a spring, arranged in the force transmission path, is sensed by a distance sensor and from the change in distance the actuation force is determined with the help of the spring constant.

The actuator travel or displacement of the brake element is also sensed on the brake cable, for which purpose a measurement unit is again required to enable a linear displacement to be sensed. In other actuation devices in vehicles, e.g. in window lift drives, the travel of the window pane actuator is sensed via the number of rotations of the drive shaft of an electric motor. Detection of the displacement in an actuation device for a vehicle parking brake with the help of the number of rotations of a drive wheel has also already been disclosed in the document U.S. Pat. No. 5,180,038.

From the prior art, various possibilities are known for measuring the number of rotations of a shaft, using arrangements of mechanical, magnetic or optical sensors. For example, with the help of Hall sensors and appropriate detection devices on the shaft it is possible to effect the detection of the number of rotations in a simple, robust and reliable way. For example, to do so a signaling wheel with segments magnetized in opposite directions can be arranged on the shaft, so that as the shaft rotates its magnetic segments move past a passive Hall sensor, which is arranged to face the signaling wheel, and modulate it in alternation. Likewise, use can be made of a passive signaling wheel with simple metallic teeth and an active Hall sensor. The accuracy of the arrangement of the signaling wheel and the sensor unit is here uncritical because it is only necessary to measure the change in the modulation of the sensor unit, and this can be guaranteed over a wide tolerance range in respect of the arrangement.

The distance measurement for the purpose of determining the actuation force can also be effected using Hall sensors. However, in this case exact positioning of the sensor and signaling units is a prerequisite for achieving the required accuracy. However, this necessitates an increased expense for design, assembly and if necessary adjustment. Correspondingly, this type of measurement is also relatively sensitive with respect to component tolerances and environmental influences, which is not without its problems, above all for an application in the particularly harsh and changing surroundings to which a motor vehicle is generally exposed.

### SUMMARY

There is thus a need for an actuator with an arrangement for measuring the actuation force and actuator travel which is as simple, robust and interference-free as possible, and which ensures high accuracy as well as low cost. In addition, the actuator should have the most compact construction possible, with the sensors arranged in close proximity to each other. It should, in particular, be suitable for a parking brake.

According to an embodiment, an actuator for a parking brake in a motor vehicle, may comprise a drive element, an output element which is coupled to the drive element via at least one elastic element, a first sensor for detecting a change in position of the drive element, and a second sensor for detecting a change in position of the output element.

According to a further embodiment, the actuator may further comprise in addition at least one traction element, which is linked to the output element. According to a further embodiment, the drive element und the output element can be arranged so that they can make rotational movements. According to a further embodiment, the at least one traction element can be a spindle. According to a further embodiment, the output element can be a spindle nut to which is attached an output gear. According to a further embodiment, the spindle nut and the output gear may be embodied in one piece. According to a further embodiment, the drive element may be a drive gear which has a positive linkage to the output gear by means of at least one tracking finger and via the at least one elastic element. According to a further embodiment, the drive gear may be mounted on the spindle nut so that it can rotate. According to a further embodiment, the elastic element may be an elastomer component. According to a further embodiment, the elastic element may be formed by tension/compression springs arranged around a circle. According to a further embodiment, the elastic element may be formed by a spiral spring. According to a further embodiment, the spindle nut may be embodied as divided with opposite sense threads, and at each end of the spindle nut is arranged a spindle with a brake cable. According to a further embodiment, the drive element and the output element may be arranged so that they can make translational movements. According to a further embodiment, the output element may be an output slider, mounted so that it can move linearly, which is joined to a brake cable. According to a further embodiment, the drive element may be a drive slider mounted so that it can move linearly, where the drive slider and the output slider are tensioned against each other by means of the elastic element. According to a further embodiment, the elastic element may be a tension/compression spring. According to a further embodiment, the drive slider may be linked to a drive spindle which has an engagement with a drive spindle nut which is coupled to a drive gear. According to a further embodiment, both the drive slider and also the output slider may be provided with an appropriate external tooth set along its lengthwise extension. According to a further embodiment, the drive gear may be driven by an electric motor. According to a further embodiment, the first sensor and the second sensor may be Hall sensors, where the first sensor is arranged opposite an external tooth set of the drive element and the second sensor opposite an external tooth set of the output element.

According to another embodiment, a method for monitoring the functioning of a parking brake, which has such an actuator, may comprise the following steps: determining the change in position of the drive element by means of the first sensor, determining the change in position of the output element by means of the second sensor, calculating a difference between the changes in position, calculating a braking force from the difference in the changes in position and a known spring force/spring travel characteristic curve for the elastic element, and Determining the correct functioning of the actuator by means of a comparison of value combinations, formed from the values determined or calculated, with stored predefined value combinations.

According to yet another embodiment, a computer program comprising program code facilities for performing all the steps of such a method when the computer program is executed on a computer.

According to yet another embodiment, a computer program product may comprise a computer readable medium having stored program codeinstructions, which when executed on a computer perform the steps of such a method.

### BRIEF DESCRIPTION OF THE DRAWINGS

The invention is shown schematically in the drawing using an exemplary embodiment and is described fully below by reference to the drawing.

FIG. 1 shows a cross-sectional view of a first embodiment of an actuator,

FIG. 2 shows a first embodiment of an elastic element in a first embodiment, along the line A-A in FIG. 1,

FIG. 3 shows a second embodiment of an elastic element in a first embodiment, along the line A-A in FIG. 1,

FIG. 4 shows a cross-sectional view of a region of an actuator in a second embodiment,

FIG. 5 shows a simplified flow diagram of a method for monitoring the functioning of a parking brake, comprising steps S1 to S6.

### DETAILED DESCRIPTION

Here, the actuator incorporates a drive element, an output element which is coupled to the drive element via at least one elastic element, a first sensor for detecting a change in the position of the drive element and a second sensor for detecting a change in the position of the output element.

The proposed solution provides that both the actuation force and also the actuator travel are determined by reference to a differential travel measurement. For this purpose, either the linear or the rotational travel of two elements (the drive and output elements) arranged in the force transmission path which are coupled by an elastic element is measured against the stationary environment. The drive element and the output element can thus be arranged to be movable in either a rotational or translational sense. The linear or rotational travel can here be measured using simple pulse generation units.

The drive element can here be driven on the drive side by, for example, an electric motor. The drive movement is transmitted via the elastic element to the output element which, in turn, is permanently coupled to the output side of the transmission unit. At least one traction element can be provided, this being linked to the output element.

In accordance with one embodiment, the driven actuator can be embodied as a brake actuator for the parking brake on a motor vehicle. This will be explained below:

When the brake is pulled on, the drive element and the output element move uniformly until the brake elements make contact in the wheel brake. The distances moved by the drive element and by the output element of the actuator are here sensed independently of each other. As soon as the brake elements make contact in the wheel brake, the movement of the drive element is halted. If the drive continues to be activated, the drive element continues to be moved relative to the now stationary output element, against the spring force of the elastic element. As a result, the actuation force increases continuously, corresponding to the spring constant of the spring unit, and the actuator travel of the drive element increases correspondingly, and continues to be sensed. The result is an actuator travel for the drive element which is greater in total than that of the output element. A comparison of the actuator travels for the drive and output elements, in a control unit which can be arranged within or outside the actuator, gives an actuator travel difference which represents a measure of the actuation force which has built up. This actuator travel difference is continuously determined by the control unit, and the drive continues to be activated until the actuator travel difference is reached which corresponds to the actuation force set-point value.

Structurally, the drive and output components are arranged in close proximity, which also permits the sensors to be arranged close to each other in their surrounding housing, for example on a common mounting unit.

In one embodiment, provision can be made that the at least one traction element is a spindle.

In addition, provision can be made that the output element is a spindle nut, on which is attached an output gear.

Further, it is advantageous if the spindle nut and the output gear are embodied in one piece with each other.

The drive element can be a drive gear which has a positive linkage with the output gear by means of at least one tracking finger or some other suitably constructed tracking element and via the at least one elastic element.

The drive gear can be mounted on the spindle nut so that it can rotate.

The elastic element can consist of several individual compression or tension springs which, for example, are arranged on a circle between the drive and output wheel. However, it can also consist of a concentrically arranged spiral spring, an elastomer component or some other elastic component, suitably arranged.

The actuator can be embodied as a so-called “180° dual-cable pull”. In this, the spindle nut is embodied as divided, with opposing sense threads, and arranged at each end of the spindle nut is a spindle with a brake cable.

In another embodiment, the drive element and the output element are arranged to be moveable in a translational sense.

Here, the output element can be an output slider which is mounted so that it can move linearly and is connected to a brake cable.

In addition, the drive element can be a drive slider which is mounted so that it can move linearly, where the drive slider and the output slider are counter-tensioned by means of the elastic element.

In this embodiment, the elastic element can advantageously be a tension-compression spring.

The drive slider can be joined to a drive spindle which has an engagement with a drive spindle nut which is linked to a drive gear.

Both the drive slider and also the output slider can be provided with an appropriate external tooth set along each of their lengthwise extensions.

The measurement arrangement for sensing the correct functioning of the actuator can thus be arranged between a spindle and a traction cable linked to the spindle via the measurement arrangement.

In general, the drive gear can be driven by an electric motor. As has already been described, the electric motor then engages with a gear, for example via a worm, which drives the spindle nut. In this way, the rotational movement of the electric motor is converted to a translational movement. This gives the possibilities described, of arranging a measuring system for sensing changes in position in the force transmission path either in such a way that rotational changes in position are measured or even arranging it at some other point so that translational changes in position are measured.

In general, it is also possible to provide just one sole traction element. The actuator can thus also be embodied as a so-called “single-cable pull”.

The first sensor and the second sensor can be Hall sensors, where it is advantageous if the first sensor is arranged opposite to an external tooth set on the drive element and the second sensor opposite an external tooth set on the output element.

As already described, this provides a particularly simple and interference-resistant sensing of the positional changes.

A corresponding method for monitoring the functioning of an actuator incorporates the steps of determining the change in position of the drive element by means of the first sensor, determining the change in position of the output element by means of the second sensor, calculating a difference in the positional changes, determining a braking force from the calculated difference and a known characteristic curve for the elastic element's spring force/spring travel, and determining the correct functioning of the parking brake by means of a comparison of a pair of values or a triplet of values, as appropriate, determined from the positional changes which have been determined, if necessary including referring to the braking force which has been determined, with known critical value pairs or triplets respectively.

The critical value triplet which is stored could be, for example, no change in the position of the output element, an arbitrary change in position of the output element, and the resulting difference. A value triplet of this type could then reflect a jammed brake system.

A computer program for executing a method as described above has program code facilities for carrying out all the steps of a method in accordance with an embodiment when the computer program is executed on a computer, in particular a control unit assigned to the actuator.

A computer program product incorporates program code facilities, which are stored on a computer-readable data medium, such as hard disks, diskettes, CD-ROMs, DVDs etc., for carrying out all the steps in a method as described above when the computer program is executed on a computer, in particular a control unit assigned to the actuator.

Further advantages and embodiments derive from the description and the appended drawing.

It goes without saying that the features cited above and those yet to be explained below can be used not only in the combination described in each case but also in other combinations or in isolation, without going outside the bounds of the present invention.

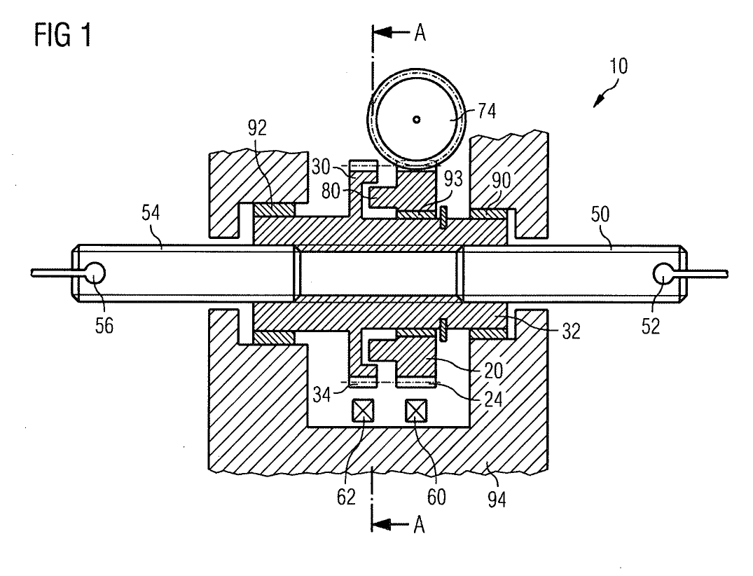

FIGS. 1, 2 and 3 show a first embodiment of an actuator 10. In the present example, the actuator 10 is used for operating a parking brake in a motor vehicle.

In the case of this actuator 10, a conventional electric motor (not shown) with a drive worm 74 is used as the drive unit. A spindle transmission consisting of a drive gear 20, an output gear 30 and a spindle nut 32 is used to convert the rotary movement of the electric motor (not shown) into a movement with a linear travel.

The output gear 30 is embodied in one piece with the spindle nut 32 and by means of tracking fingers 80, 82, 84 and at least one elastic element 40, 42, 44, 46 has a positive linkage with the output gear 20, which is mounted on the spindle nut 32 by means of a bearing, so that it can rotate.

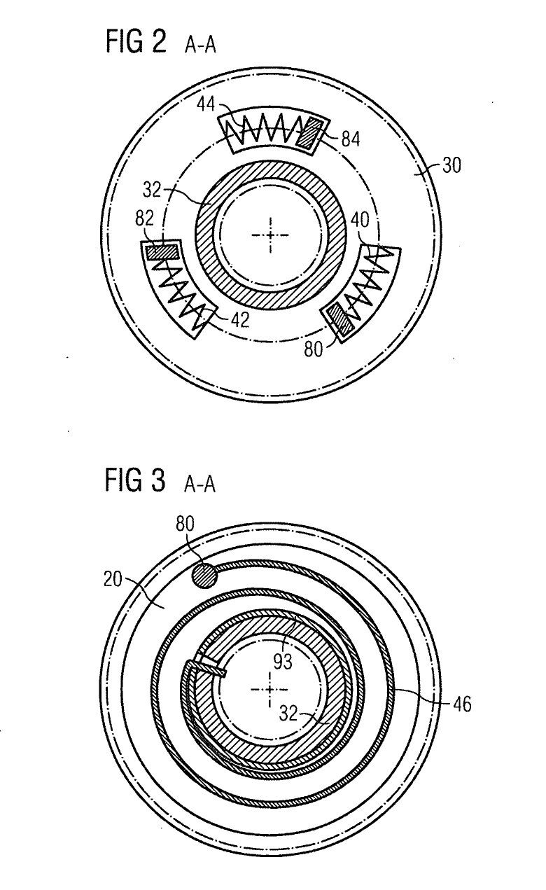

The elastic element can be tension/compression springs 40, 42, 44 arranged in a circle, as shown in FIG. 2. However, a spiral spring 46 can also be provided, as shown in FIG. 3.

The spindle nut 32 is mounted in a housing 94 by means of two bearings 90, 92 so that it can rotate. The drive gear 20 engages with a drive worm 74 which is driven by the electric motor. The actuator shown in FIG. 1 is constructed as a so-called “180° dual-cable pull”, so that the spindle nut 32 is provided with opposing sense threads, and two contra-rotating spindles 50, 54 are provided. The spindles 50, 54 engage with the spindle nut 32 and can move linearly relative to the housing 94 but are locked against rotation. Fixed to each of the spindles 50, 54 is a brake cable 52, 56, to which the linear movement of the spindle concerned 50,54 is transmitted.

The drive gear 20 has external teeth 24. The output gear 30 has external teeth 34. Arranged in the region of the external teeth 24, 34 on the drive gear 20 and on the output gear 30 is in each case an active Hall sensor 60, 62. The Hall sensor concerned 60, 62 is modulated by the corresponding teeth 24, 34 on the drive gear 20 and the output gear 30 respectively. During rotation of the drive gear 20 or the output gear 30 one impulse is produced for each tooth as the teeth 24, 34 respectively move past the Hall sensors 60, 62. By counting the pulses it is possible to determine the rotational angle of the drive gear 20 and the output gear 30 respectively. Using a predefined transmission ratio for the spindle transmission, it is thus possible, using the count of the pulses from the output wheel, to determine the linear travel of the spindle and hence also of the brake cables. From the difference in the numbers of pulses from the drive gear 20 and the output gear 30 it is possible to determine the differential angle between the drive wheel and the output wheel, and the torque transmitted by the elastic element 40, 42, 44, 46, which in turn is proportional to the actuation force.

The measurement data items which are sensed are transmitted to a control or regulation unit (not shown), which evaluates the measurement data and controls the electric motor accordingly.

The particular advantage of this embodiment is its constructional simplicity and the central arrangement of the elements, in close spatial proximity to each other. A further advantage lies in the fact that this actuator 10 with combined actuator travel/actuation force measurement can equally well be made as a “single cable pull” or a “180° dual-cable pull”.

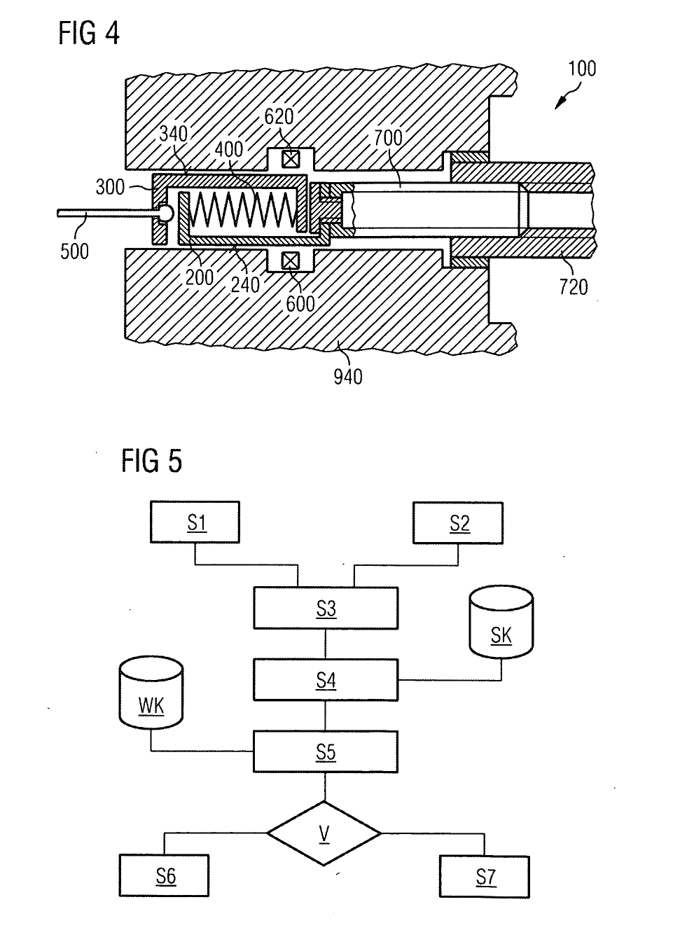

FIG. 4 shows a second embodiment of an actuator 100. In this embodiment, an appropriate brake cable 500 is joined to a spindle 700 via a measurement arrangement. A movement of the spindle 700 is effected by a spindle transmission and an electric motor, in a way similar to the first embodiment, where the spindle nut 720 is of course connected without interposition of the measurement arrangement shown in the figure but directly via a drive gear to an electric motor.

The measurement device in the second embodiment consists of a drive slider 200, which is coupled to the spindle 700, and in addition an output slider 300, which is coupled to a brake cable 500. The two sliders 200, 300 are mounted in a housing 940 so that they can move linearly, independently of each other. Arranged between the drive slider 200 and the output slider 300 is a compression spring 400 which acts as the elastic element according to an embodiment and tensions the two sliders 200, 300 against each other. If the actuator is operated, the tension from the drive slider 200 is transmitted via the compression spring 400 to the output slider 300.

Each slider 200, 300 has a linearly arranged set of teeth 240, 340 on an external side. Arranged opposite each set of teeth is a Hall sensor 600, 620, which is modulated by the individual teeth.

When the actuator is operated or the brake pulled on, as applicable, the two sliders 200, 300 move uniformly until the brake elements of the wheel brakes (not shown) make contact. This causes the movement of the output slider 300 to stop. If the drive continues to be activated, then the drive slider 200 continues to move on in the pull-on direction (towards the right in FIG. 4) until the desired braking force is achieved.

During the linear movement of the two sliders 200, 300, the individual teeth of the linear tooth sets 240, 340 move past the Hall sensors 600, 620 and generate corresponding pulses. The difference in the actuator travel is a measure of the tension in the brake cable 500. By counting the pulses it is possible to determine the actuator travel for each of the drive slider 200 and output slider 300 relative to the stationary housing 940, together with the difference in actuator travel.

This embodiment is suitable above all for so-called single cable pulls, and has the advantage that the tension in the brake cable 500 can here be measured directly, i.e. with no effects from a gearing ratio. In the case of a two-cable pull it may be necessary to provide a separate measuring device in each cable. In addition, there is the advantage that the Hall sensors 600, 620 can be mounted in a fixed prescribed position in the housing 940, if necessary on a common mounting element, for example a circuit substrate embodied as a circuit board, in a spatially compact arrangement.

In both embodiments, the use of Hall sensors 60, 62, 600, 620 is particularly advantageous because they have a comparatively large tolerance in respect of mis-positioning of the sensor and the signaling unit. As a result, expensive adjustment work during assembly can be eliminated. In addition, the positioning of the sensors 60, 62, 600, 620 in the housing 94, 940 can be effected during assembly without direct reference to the signaling units or the external tooth sets 24, 34, 240, 340, as applicable, and without subsequent calibration of the measured values.

It thus permits a particularly simple and rapid, and hence low-cost, assembly of the actuator.

FIG. 5 shows a simplified flow diagram of the function monitoring of a parking brake which has an actuator. The method contains the procedural steps labeled S1 to S6 in FIG. 5:
Step S1: Determine the change in position of the drive element 20, 200 by means of the second sensor 60, 600.
Step S2: Determine the change in position of the output element 30, 32, 300 by means of the second sensor 62, 620.

The determinations of the values in steps S1 and S2 are made in parallel from a timing point of view.
Step S3: Calculate a difference between the changes in position.
Step S4: Calculate a braking force from the difference in the changes in position and a known spring force/spring travel characteristic curve for the elastic element 40, 42, 44, 46, 400, if necessary making reference to further system-specific characteristic values which are made available in a memory SK together with the spring force/spring travel characteristic curve.
Step S5: Determine the correct functioning of the parking brake 10, 100 by means of a comparison of value combinations, formed from the values determined and/or calculated, with specified value combinations stored in a memory WK.

Provided that the parking brake is determined in step S5 to have a problem-free functioning ability, then in the procedural branch step V a branch takes place to procedural step S6.
Step S6: Output a signal to confirm the function to the actuator's control unit and/or to the operator.

If a malfunction of the parking brake is detected in step S5, then in the procedural branch step V a branch takes place to procedural step S7.
Step S7: Output a signal to initialize an emergency routine in the control unit and to generate an indication signal calling the user's attention to the malfunction.

### LIST OF REFERENCE MARKS

10 Brake actuator
20 Drive gear
24 External teeth
30 Output gear
32 Spindle nut
34 External teeth
40,42,44 Tension/compression spring
46 Spiral spring
50,54 Spindle
52,56 Brake cable
60, 62 Hall sensor
74 Drive worm
80, 82, 84 Tracking finger
90,92, 93 Bearing
94 Housing
100 Brake actuator
200 Drive slider
240 External teeth
300 Output slider
340 External teeth
400 Tension/compression spring
500 Brake cable
600, 620 Hall sensor
700 Drive spindle
720 Drive spindle nut
940 Housing
SK Memory
WK Memory
V Procedural branch step
S1, . . . , S7 Procedural steps

What is claimed is:

1. An actuator for a parking brake in a motor vehicle, comprising:
a drive element,
an output element which is coupled to the drive element via at least one elastic element,
a first sensor for detecting a change in position of the drive element, and
a second sensor for detecting a change in position of the output element.

2. The actuator according to claim 1, further comprising in addition at least one traction element, which is linked to the output element.

3. The actuator according to claim 1, wherein the drive element und the output element are arranged so that they can make rotational movements.

4. The actuator according to claim 2, wherein the at least one traction element is a spindle.

5. The actuator according to claim 1, wherein the output element is a spindle nut to which is attached an output gear.

6. The actuator according to claim 5, wherein the spindle nut and the output gear are embodied in one piece.

7. The actuator according to claim 5, wherein the drive element is a drive gear which has a positive linkage to the output gear by means of at least one tracking finger and via the at least one elastic element.

8. The actuator according to claim 7, wherein the drive gear is mounted on the spindle nut so that it can rotate.

9. The actuator according to claim 7, wherein the elastic element is an elastomer component.

10. The actuator according to claim 7, wherein the elastic element is formed by tension/compression springs arranged around a circle.

11. The actuator according to claim 7, wherein the elastic element is formed by a spiral spring.

12. The actuator according to claim 5, wherein the spindle nut is embodied as divided with opposite sense threads, and at each end of the spindle nut is arranged a spindle with a brake cable.

13. The actuator according to claim 1, wherein the drive element and the output element are arranged so that they can make translational movements.

14. The actuator according to claim 1, wherein the output element is an output slider, mounted so that it can move linearly, which is joined to a brake cable.

15. The actuator according to claim 1, wherein the drive element is a drive slider mounted so that it can move linearly, where the drive slider and the output slider are tensioned against each other by means of the elastic element.

16. The actuator according to claim 15, wherein the elastic element is a tension/compression spring.

17. The actuator according to claim 15, wherein the drive slider is linked to a drive spindle which has an engagement with a drive spindle nut which is coupled to a drive gear.

18. The actuator according to claim 15, wherein both the drive slider and also the output slider is provided with an appropriate external tooth set along its lengthwise extension.

19. The actuator according to claim 5, wherein the drive gear is driven by an electric motor.

20. The actuator according to claim 1, wherein the first sensor and the second sensor are Hall sensors, where the first sensor is arranged opposite an external tooth set of the drive element and the second sensor opposite an external tooth set of the output element.

21. A method for monitoring the functioning of a parking brake, which has an actuator according to claim 1, comprising the following steps:
determining the change in position of the drive element by means of the first sensor,
determining the change in position of the output element by means of the second sensor,
calculating a difference between the changes in position,
calculating a braking force from the difference in the changes in position and a known spring force/spring travel characteristic curve for the elastic element,
Determining the correct functioning of the actuator by means of a comparison of value combinations, formed from the values determined or calculated, with stored predefined value combinations.

22. (canceled)

23. A computer program product comprising a computer readable medium having stored program code instructions, which when executed on a computer perform the steps of the method as claimed in claim 21.
